(19) United States
(12) Patent Application Publication
(10) Pub. No.: US 2025/0050378 A1
(43) Pub. Date: Feb. 13, 2025

(54) VEHICLE INCLUDING MULTI-TONE PAINT SCHEME

(71) Applicant: GM GLOBAL TECHNOLOGY OPERATIONS LLC, Detroit, MI (US)

(72) Inventors: Hua-tzu Fan, Troy, MI (US); Marcel James Isrow, Sterling Heights, MI (US); Ryan J. Odegaard, Ludington, MI (US); John Patrick Spicer, Plymouth, MI (US); Michael J. Moore, Rochester, WI (US); Robert Dale Burns, Lake Orion, MI (US); Jorge F. Arinez, Rochester Hills, MI (US)

(21) Appl. No.: 18/230,865

(22) Filed: Aug. 7, 2023

(51) Int. Cl. B05D 7/00; B05D 1/34; B05D 1/38; B05D 3/02; B05D 3/06

(52) U.S. Cl. CPC B05D 7/56; B05D 1/34; B05D 1/38; B05D 3/0272; B05D 3/067; B05D 2400/00; B05D 2425/01; B05D 2425/02

(57) ABSTRACT

A method for painting a body of a vehicle with a multi-tone paint scheme. The method includes: applying a first paint of a first color to the body; oven-curing the first paint; applying a second paint of a second color to the body, the second paint configured to be cured by ultraviolet light, the second color is different from the first color, and curing the second paint by exposing the second paint to ultraviolet light.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a vehicle including a multi-tone paint scheme and methods for applying the multi-tone paint scheme.

Vehicle bodies often have a single-tone paint scheme, which means that the body is painted to have only one color. Some vehicle bodies have a two-tone paint scheme, which means that different areas of the body are painted in different colors. For example, a vehicle painted with a two-tone paint scheme may have a roof and an area of the body below the roof painted in different colors. A two-tone paint scheme typically requires more time and energy to apply as compared to a single-tone paint scheme.

### SUMMARY

The present disclosure includes, in various features, a method for painting a body of a vehicle with a multi-tone paint scheme. The method includes: applying a first paint of a first color to the body; oven-curing the first paint; applying a second paint of a second color to the body, the second paint configured to be cured by ultraviolet light, the second color is different from the first color; and curing the second paint by exposing the second paint to ultraviolet light.

In further features, the first paint is applied to a greater portion of the body as compared to the second paint.

In further features, the present disclosure includes applying the second paint to a roof of the body.

In further features, the present disclosure includes applying the first paint in multiple coats including an ultraviolet protection primer, a basecoat including the first color, and a protective clearcoat over the basecoat.

In further features, the second paint is applied onto the protective clearcoat.

In further features, the preset disclosure includes applying an adhesive layer on a metal substrate of the body, and applying a corrosion protection layer between the adhesive layer and the ultraviolet protection primer.

In further features, the preset disclosure includes applying the second paint with an overspray-free printhead.

In further features the overspray-free printhead is configured to apply the second paint without atomizing the second paint.

In further features the present disclosure includes applying a third paint of a third color to the body using an overspray-free printhead, the third paint is configured to be cured by ultraviolet light; and exposing the third paint to ultraviolet light to cure the third paint.

In further features, the present disclosure includes simultaneously applying the second paint and the third paint to the body with an overspray-free applicator including multiple printheads.

In further features, the present disclosure includes applying the second paint to the body and curing the second paint with ultraviolet without moving the vehicle.

The present disclosure includes, in various features, a method for painting a body of a vehicle with a multi-tone paint scheme. The method includes: applying a first paint of a first color to the body; oven-curing the first paint; applying a second paint of a second color onto less than an entirety of the first paint with a non-atomizing paint applicator, the second paint configured to be cured by ultraviolet light, and the second color is different from the first color; applying a third paint of a third color onto one of the second paint and the first paint with the non-atomizing paint applicator, the third paint configured to be cured by ultraviolet light; and curing the second paint and the third paint by exposing the second paint and the third paint to ultraviolet light.

In further features, the present disclosure includes simultaneously curing the second paint and the third paint with ultraviolet light.

In further features, the present disclosure includes curing the second paint prior to applying the third paint.

In further features, the present disclosure includes applying the second paint and the third paint to paint at least one of the following onto the vehicle: a stripe; a wave; non-linear lines; a logo; a geometric shape; and a picture.

The present disclosure includes, in various features, a vehicle including a multi-tone paint scheme, the vehicle includes: a first paint of a first color painted onto a body of the vehicle; and a second paint of a second color painted onto the first paint with a non-atomizing paint applicator, the second paint configured to be cured by ultraviolet light, and the second color different from the first color.

In further features, the body includes a roof, and the second paint is painted onto the roof.

In further features, the present disclosure provides for a third paint of a third color painted onto one of the first paint and the second paint with the non-atomizing paint applicator, the third paint configured to be cured by ultraviolet light.

In further features, the first paint covers an entirety of an exterior of the body, and the second paint covers less than the entirety of the exterior of the body.

In further features, the first paint includes the following layers: an adhesive layer on a metal substrate of the body; a corrosion protection layer on the adhesive layer; an ultraviolet protection primer on the corrosion protection layer; a basecoat of the first color on the ultraviolet protection primer; and a protective clearcoat on the basecoat; and the second paint includes a single layer on the protective clearcoat.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a body of a vehicle painted in a two-tone paint scheme in accordance with the present disclosure;

FIG. 2 illustrates layers of the two-tone paint scheme in accordance with the present disclosure;

FIG. 3 illustrates a method in accordance with the present disclosure for painting a surface with a multi-tone paint scheme in accordance with the present disclosure;

FIG. 4 illustrates an exemplary applicator for painting a surface with multiple colors of UV-curable paint simultaneously with an overspray-free paint head;

FIG. 5 illustrates a vehicle body painted in a multiple-tone paint scheme in accordance with the present disclosure;

FIG. 6 illustrates a vehicle body painted in an additional multiple-tone paint scheme in accordance with the present disclosure;

FIG. 7 illustrates a vehicle body painted in yet another multiple-tone paint scheme in accordance with the present disclosure; and

FIG. 8 illustrates a vehicle body painted in a further multiple-tone paint scheme in accordance with the present disclosure.

In the drawings, reference numbers may be reused to identify similar and/or identical elements.

### DETAILED DESCRIPTION

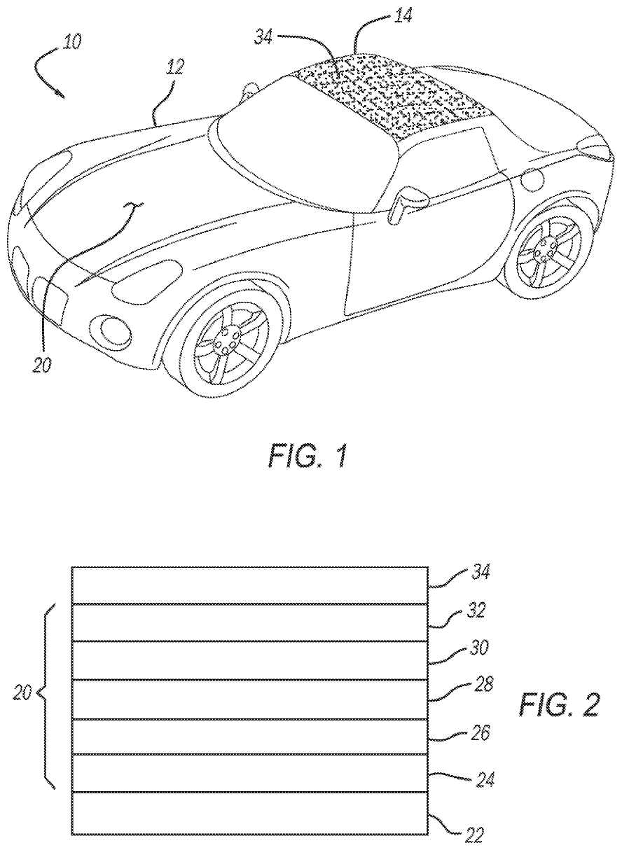

FIG. 1 illustrates an exemplary vehicle 10 painted in accordance with the present disclosure. Although the vehicle 10 is illustrated as a passenger vehicle, the present disclosure applies to any other suitable vehicle as well, such as any suitable commercial vehicle, mass transit vehicle, military vehicle, utility vehicle, construction vehicle, aircraft, watercraft, etc. The present disclosure also applies to non-vehicular applications as well, such as any suitable equipment, structure, building, etc.

The exemplary vehicle 10 of FIG. 1 includes a body 12 having a roof 14. The body 12 is painted with a multicoat paint 20 having a first color. The roof 14 is painted with an ultraviolet (UV) curable paint layer 34 having a second color, which is different from the first color of the multicoat paint 20. An entirety of an exterior of the body 12 is first painted with the multicoat paint 20. After the multicoat paint 20 is cured by oven curing, the UV curable paint layer 34 is applied onto the multicoat paint 20 at any desired location about the body 12, such as on the roof 14 as illustrated in FIG. 1. In the example of FIG. 1, the UV curable paint layer 34 is applied to an entirety of the roof. However, the UV curable paint layer 34 may be applied at any other suitable location about the body 12.

The UV curable paint layer 34 may be any suitable UV curable clearcoat with pigments added thereto to provide the clearcoat with any suitable color as the second color. Iron oxide black or carbon black may be added as a black pigment. Titanium or zinc oxide may be added as a white pigment. Any other suitable color pigment may be added to the UV curable clearcoat to provide the UV curable clearcoat with other colors. The amount of pigment added to the UV curable clearcoat may range from 1% by weight to 40% by weight depending on the desired color.

The UV curable paint layer 34 is applied with any suitable overspray-free applicator. Exemplary overspray-free applicators include, but are not limited to, the EcoPaintJet overspray-free applicator offered by Dürr Systems AG of Germany (and Dürr Systems, Inc. of Southfield, Michigan). Any other suitable overspray-free paint applicator may be used, such as any applicator suitable to apply the UV curable paint layer 34 without atomizing the UV curable paint layer 34.

FIG. 2 illustrates exemplary layers of the multicoat paint 20 applied to a metal substrate 22 of the body 12. The multicoat paint 20 includes an adhesive layer 24 applied to the metal substrate 22 in the form of a thin film or phosphate. A corrosion protection layer 26 is applied to the adhesive layer 24 by electrodeposition. On the corrosion protection layer 26 is an ultraviolet (UV) protection primer 28. A basecoat 30 having the first color is applied onto the UV protection primer 28. A protective clearcoat 32 is applied over the basecoat 30. The layers of the multicoat paint 20 are cured in any suitable oven.

After the multicoat paint 20 is cured, the UV curable paint layer 34 having the second color is applied onto the multicoat paint 20 at any desired position on the body 12 using the overspray-free print head to apply the UV curable paint layer 34 without overspray. As a result, any need to mask the body 12 is eliminated. Because the UV protection primer 28 in the multicoat paint 20 provides UV protection, the UV curable paint layer 34 no longer needs to provide UV blockers in its composition. Therefore, the UV curable paint 34 formulation is no longer limited by contradictive requirements of simultaneous UV curing and UV blocking, which improves the formulation flexibility of the UV curable paint layer 34. Although FIGS. 1 and 2 illustrate only the UV curable paint layer 34, multiple UV curable paint layers may be included with the UV curable paint layer 34 being a first UV curable paint layer. The additional UV curable paint layers may be applied directly onto the multicoat paint 20, onto the UV curable paint layer 34, or onto other UV curable paint layers, as explained further herein.

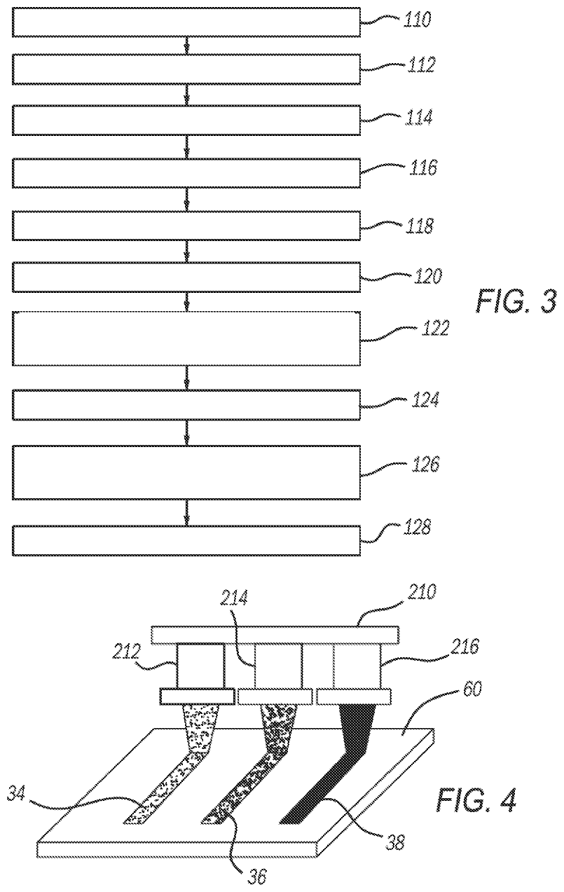

FIG. 3 illustrates an exemplary method in accordance with the present disclosure for painting the body 12 of the vehicle 10, or any other suitable surface, with a multi-tone paint scheme. At block 110 the adhesive layer 24 is applied to the metal substrate 22 of the body 12, or any other suitable surface. At block 112, the corrosion protection layer 26 is applied to the adhesive layer 24, such as by electrodeposition. At block 114, the UV protection primer 28 is applied onto the corrosion protection layer 26. At block 116, the basecoat 30 having the first color is applied onto the UV protection primer 28. At block 118, the protective clearcoat 32 is applied to the basecoat 30, which completes the application of the multicoat paint 20.

At block 120, the multicoat paint 20 is cured in any suitable oven. The vehicle 10 may be moved from a first location where the multicoat paint 20 is applied to a second location including the oven where the multicoat paint 20 is cured. From the oven, the body 12 is moved to any suitable location where, at block 122, the UV curable paint layer 34 is applied to the multicoat paint 20 at any suitable position on the body 12. In the example of FIG. 1, the UV curable paint layer 34 is applied to the roof 14. The UV curable paint layer 34 is applied using any suitable overspray-free applicator, such as an applicator configured to apply the UV curable paint without atomizing the UV curable paint. The overspray-free applicator may be mounted to any suitable robotic arm to facilitate the deposition of the paint on the body 12.

At block 124, the UV curable paint layer 34 is cured by exposing the UV curable paint layer 34 to ultraviolet (UV) light. The UV curable paint layer 34 may be exposed to ultraviolet light at the same location where the UV curable paint layer 34 is applied, which eliminates the need to transport the body 12 to another curing location, thereby saving time, space, and energy. The UV light source may be mounted to a robotic arm for moving the UV light source to help direct the UV light to the UV curable paint layer 34.

Any suitable number of UV curable paint layers may be applied to the body 12. For example, at block 126 a second UV curable paint layer 36 having a third color may be applied onto the multicoat paint 20 or onto the first UV curable paint layer 34 using the overspray-free applicator. At block 128, the second UV curable paint layer 36 is cured with UV light. Any suitable number of additional UV curable paint layers may be applied to the body 12 using an overspray-free applicator so as to not atomize the UV curable paint layers. For example, FIG. 4 illustrates a third UV curable paint layer 38. Because the UV protection primer 28 and the basecoat 30 provide UV protection to the corrosion protection layer 26, the UV curable paint layers 34, 36, 38 (as well as any additional UV curable paint layers) need not include UV blocking properties. The UV radiation for curing the UV curable paint layers 34, 36, 38 (as well as any additional UV curable paint layers) may be provided from any suitable source, such as robot-mounted UV LED lamps.

Although FIG. 3 illustrates curing with UV light at blocks 124 and 128 after each of the first and second UV curable paint layers 34 and 36 are applied, the UV curable paint layers 34, 36, 38, etc. may be applied and then cured simultaneously with UV light. In other words, the UV curing at block 124 is optional because the second UV curable paint layer 36 may be applied before the first UV curable paint layer 34 is cured.

With reference to FIG. 4, multiple UV curable paint layers may be applied simultaneously by an overspray-free applicator 210 including multiple print heads. In the example of FIG. 4, the UV curable paint layers 34, 36, and 38 may be simultaneously applied by a first overspray-free print head 212, a second overspray-free print head 214, and a third overspray-free print head 216 respectively. The overspray-free applicator 210 and the print heads 212, 214, and 216 thereof are configured to apply the UV curable paint layers 34, 36, and 38 without atomizing the UV curable paint layers 34, 36, and 38. The overspray-free applicator 210 may be configured such that the print heads 212, 214, 216 are movable to provide various patterns of deposition. For example, the distance between the print heads 212, 214, 216 may be varied. Also, the print heads 212, 214, 216 may be arranged to deposit paint in parallel lines as illustrated in FIG. 4, or in alternating patterns of colors in a single path of variable color lengths, or in any other suitable arrangement, for example.

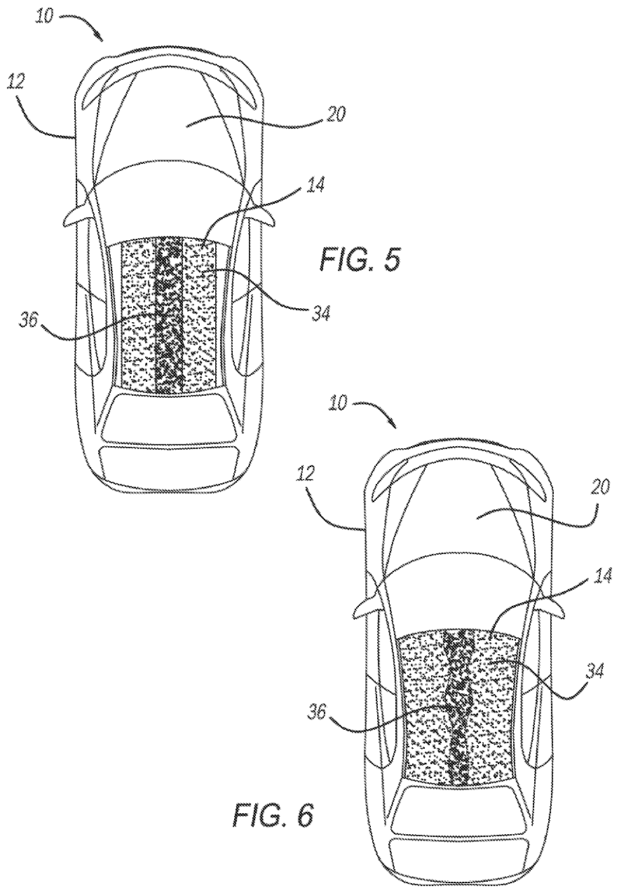

With continued reference to FIGS. 1-4, and additional reference to FIGS. 5-7, various exemplary multi-tone paint schemes in accordance with the present disclosure will now be described further. FIG. 5 illustrates the vehicle body 12 covered in the multicoat paint 20. In this example, the multicoat paint 20 is applied to an entirety of the exterior of the body 12, including an entirety of the roof 14. The multicoat paint 20 is then cured in an oven at block 120 of FIG. 3. Next, the first UV curable paint layer 34 is applied onto the multicoat paint 20 at the roof 14 with the overspray-free applicator so as to not atomize the first UV curable paint layer 34. The first UV curable paint layer 34 may be applied to an entirety of the roof 14. After the first UV curable paint layer 34 is cured by UV light at block 120, the second UV curable paint layer 36 is applied onto the first UV curable paint layer 34 using the overspray-free applicator to form a stripe as illustrated in FIG. 5. Alternately, the second UV curable paint layer 36 may be applied onto the first UV curable paint layer 34 prior to curing the first UV curable paint layer 34, and then both the first and second UV curable paint layers 34, 36 may be cured together by exposing the UV curable paint layers 34, 36 to ultraviolet light simultaneously.

Another option for printing a stripe on the roof 14, or at any other suitable location, is to apply the first UV curable paint layer 34 to a left side and a right side of the roof 14 so as to leave a gap between the left side and the right side of the first UV curable paint layer 34. The second UV curable paint layer 36 may then be applied within the gap directly onto the multicoat paint 20 using the overspray-free applicator. Prior to applying the second UV curable paint layer 36 at the gap, edges of the first UV curable paint layer 34 defining the gap may be optionally cured by ultraviolet light without curing the rest of the first UV curable paint layer 34, which saves energy. Alternatively, both the first UV curable paint layer 34 and the second UV curable paint layer 36 may be cured simultaneously. Printing the first UV curable paint layer 34 to define the gap advantageously reduces the amount of the first UV curable paint layer 34 needed to paint the multi-tone paint scheme of FIG. 5.

With reference to FIG. 6, the first UV curable paint layer 34 may be applied to the roof 14 using the overspray-free applicator such that the first UV curable paint layer 34 extends completely to the left side and the right side of the roof 14. The second UV curable paint layer 36 may be applied at a center of the roof 14 with the overspray-free applicator in a wave-like manner such that sides of the second UV curable paint layer 36 are not straight, but rather curved to give the appearance of a wavy or sinusoidal shape. The second UV curable paint layer 36 may be applied onto the multicoat paint 20 or in a gap defined by the first UV curable paint layer 34 printed with the overspray-free applicator.

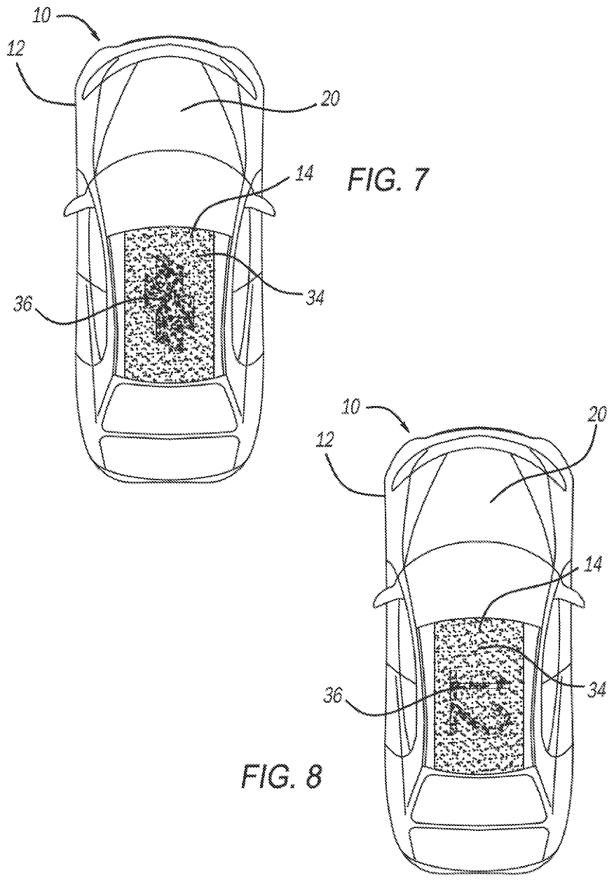

With reference to FIG. 7, the second UV curable paint layer 36 may be applied to the roof 14 on top of, or in a gap defined by, the first UV curable paint layer 34. In the example of FIG. 7, the second UV curable paint layer 36 is applied by the overspray-free applicator in the shape of any suitable logo or symbol, such as a logo of an original equipment manufacturer. With reference to FIG. 8, the second UV curable paint layer 36 may be applied onto, or in gaps defined by, the first UV curable paint layer 34 to print a number or any other suitable picture, geometric shape, non-linear lines, etc. The multi-tone paint scheme of the vehicle 10 may also include the third UV curable paint layer 38 (as well as any suitable number of additional UV curable paint layers) printed with the overspray-free applicator to form any suitable shape, logo, picture, etc.

The present disclosure provides numerous advantages. For example, using UV curable paint layers 34, 36, 38 (or yet additional UV curable paint layers of various colors) eliminates the need to transport the vehicle 10 to a separate oven curing chamber to cure the UV curable paint layers 34, 36, 38. Instead, the UV curable paint layers 34, 36, 38 may be cured at the same location where they are applied, thereby reducing paint times, conserving energy, reducing costs, etc. Applying the UV curable paint layers 34, 36, 38 (as well as any suitable number of additional UV curable paint layers) using the overspray-free applicator advantageously eliminates the need to mask the multicoat paint 20 prior to applying the UV curable paint layers 34, 36, 38, and then demasking the multicoat paint 20, thereby also saving time and energy. Furthermore, using the overspray-free applicator to apply the UV curable paint layers 34, 36, 38 allows for targeted curing with UV light, which consumes less energy than oven curing. Applying paint using atomizing applicators often results in paint being applied in areas where it would be difficult for UV light to reach. The edges of the two-tone area painted in accordance with the present disclosure are distinguishable from two-tone areas applied by a traditional spray-and-masking method. A spray-and-masked boundary will show sharp break lines from the masking operation. A UV-curable layer, such as UV curable paint layers 34, 36, 38 can also be detected by chemical analysis of the UV curable paint layer for photo initiator components.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

1. A method for painting a body of a vehicle with a multi-tone paint scheme, the method comprising:
applying a first paint of a first color to the body;
oven-curing the first paint;
applying a second paint of a second color to the body, the second paint configured to be cured by ultraviolet light, the second color is different from the first color; and
curing the second paint by exposing the second paint to ultraviolet light.

2. The method of claim 1, wherein the first paint is applied to a greater portion of the body as compared to the second paint.

3. The method of claim 1, further comprising applying the second paint to a roof of the body.

4. The method of claim 1, further comprising applying the first paint in multiple coats including an ultraviolet protection primer, a basecoat including the first color, and a protective clearcoat over the basecoat.

5. The method of claim 4, wherein the second paint is applied onto the protective clearcoat.

6. The method of claim 4, further comprising applying an adhesive layer on a metal substrate of the body, and applying a corrosion protection layer between the adhesive layer and the ultraviolet protection primer.

7. The method of claim 1, further comprising applying the second paint with an overspray-free printhead.

8. The method of claim 7, wherein the overspray-free printhead is configured to apply the second paint without atomizing the second paint.

9. The method of claim 1, further comprising applying a third paint of a third color to the body using an overspray-free printhead, the third paint is configured to be cured by ultraviolet light; and
exposing the third paint to ultraviolet light to cure the third paint.

10. The method of claim 9, further comprising simultaneously applying the second paint and the third paint to the body with an overspray-free applicator including multiple printheads.

11. The method of claim 1, further comprising applying the second paint to the body and curing the second paint with ultraviolet without moving the vehicle.

12. A method for painting a body of a vehicle with a multi-tone paint scheme, the method comprising:
applying a first paint of a first color to the body;
oven-curing the first paint;
applying a second paint of a second color onto less than an entirety of the first paint with a non-atomizing paint applicator, the second paint configured to be cured by ultraviolet light, and the second color is different from the first color;
applying a third paint of a third color onto one of the second paint and the first paint with the non-atomizing paint applicator, the third paint configured to be cured by ultraviolet light; and
curing the second paint and the third paint by exposing the second paint and the third paint to ultraviolet light.

13. The method of claim 12, further comprising simultaneously curing the second paint and the third paint with ultraviolet light.

14. The method of claim 12, further comprising curing the second paint prior to applying the third paint.

15. The method of claim 12, further comprising applying the second paint and the third paint to paint at least one of the following onto the vehicle: a stripe; a wave; non-linear lines; a logo; a geometric shape; and a picture.

16. A vehicle including a multi-tone paint scheme, the vehicle comprising:
a first paint of a first color painted onto a body of the vehicle; and
a second paint of a second color painted onto the first paint with a non-atomizing paint applicator, the second paint configured to be cured by ultraviolet light, and the second color different from the first color.

17. The vehicle of claim 16, wherein the body includes a roof, and the second paint is painted onto the roof.

18. The vehicle of claim 16, further comprising a third paint of a third color painted onto one of the first paint and the second paint with the non-atomizing paint applicator, the third paint configured to be cured by ultraviolet light.

19. The vehicle of claim 16, wherein the first paint covers an entirety of an exterior of the body, and the second paint covers less than the entirety of the exterior of the body.

20. The vehicle of claim 16, wherein:
the first paint includes the following layers: an adhesive layer on a metal substrate of the body; a corrosion protection layer on the adhesive layer; an ultraviolet protection primer on the corrosion protection layer; a basecoat of the first color on the ultraviolet protection primer; and a protective clearcoat on the basecoat; and
the second paint includes a single layer on the protective clearcoat.
